(19) United States
(12) Patent Application Publication
(10) Pub. No.: US 2025/0008554 A1
(43) Pub. Date: Jan. 2, 2025

(54) PHYSICAL UPLINK SHARED CHANNEL (PUSCH) REPETITIONS AFTER IDLE PERIOD IN FRAME-BASED EQUIPMENT (FBE)

(71) Applicant: QUALCOMM Incorporated, San Diego, CA (US)

(72) Inventors: Shaozhen GUO, Beijing (CN); Jing SUN, San Diego, CA (US); Changlong XU, Beijing (CN); Xiaoxia ZHANG, San Diego, CA (US)

(21) Appl. No.: 18/702,762

(22) PCT Filed: Nov. 13, 2021
(86) PCT No.: PCT/CN2021/130482

§ 371 Date: Apr. 18, 2024

(51) Int. Cl. H04W 74/04; H04W 74/00

(52) U.S. Cl. CPC H04W 74/04; H04W 74/004

(57) ABSTRACT

A method of wireless communication by a user equipment (UE) operating in frame-based equipment (FBE) mode includes transmitting, to a base station, during a shared base station first channel occupancy time (COT), a first physical uplink shared channel (PUSCH) actual repetition prior to an idle period in a first fixed frame period of the base station. The method also includes attempting to detect a downlink signal during a second COT in a second fixed frame period of the base station that occurs immediately after the idle period. The method further includes transmitting a second PUSCH actual repetition in the second fixed frame period after the idle period, in response to detecting the downlink signal and in response to a processing timeline being satisfied.

### FIELD OF THE DISCLOSURE

The present disclosure relates generally to wireless communications, and more specifically to Type-B physical uplink shared channel (PUSCH) repetitions after an idle period in frame-based equipment (FBE).

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communications link from the BS to the UE, and the uplink (or reverse link) refers to the communications link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

Aspects generally include a method, apparatus, system, computer program product, non-transitory computer-readable medium, user equipment, base station, wireless communications device, and processing system as substantially described with reference to and as illustrated by the accompanying drawings, specification, and appendix.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIGS. 3-9 illustrate various timelines for physical uplink shared channel (PUSCH) repetitions after an idle period in a frame-based equipment (FBE) mode, according to aspects of the present disclosure.

FIG. 10 is a flow diagram illustrating an example process performed, for example, by a user equipment (UE), in accordance with various aspects of the present disclosure.

FIG. 11 is a flow diagram illustrating an example process performed, for example, by a user equipment (UE), in accordance with various aspects of the present disclosure.

FIG. 12 is a flow diagram illustrating an example process performed, for example, by a user equipment (UE), in accordance with various aspects of the present disclosure.

FIG. 13 is a flow diagram illustrating an example process performed, for example, by a user equipment (UE), in accordance with various aspects of the present disclosure.

FIG. 14 is a flow diagram illustrating an example process performed, for example, by a base station, in accordance with various aspects of the present disclosure.

FIG. 15 is a flow diagram illustrating an example process performed, for example, by a base station, in accordance with various aspects of the present disclosure.

FIG. 16 is a flow diagram illustrating an example process performed, for example, by a base station, in accordance with various aspects of the present disclosure.

Appendix A is a document that describes aspects of the claimed subject matter. Appendix A forms part of this specification and is expressly incorporated herein by reference in its entirety.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

A physical uplink shared channel (PUSCH) is a set of time and frequency resources used for transmission from the user equipment (UE) to the base station. A PUSCH transmission is not permitted to cross a slot boundary. Therefore, to avoid transmitting a long PUSCH across a slot boundary, the UE transmits multiple small PUSCH repetitions. These repetitions may be referred to as Type-B PUSCH repetitions.

Wireless communications in unlicensed spectrum may occur in a semi-static channel access mode (e.g., frame-based equipment (FBE) mode). For UEs operating in FBE mode, Type-B PUSCH repetition orphan symbols are dropped. An orphan symbol is a single symbol after segmentation. If a nominal repetition overlaps with a set of symbols in an idle period, all symbols in the idle period are considered to be invalid symbols. Nominal repetitions are segmented around the invalid symbols.

In a semi-static channel access mode (e.g., FBE mode), a UE may share a base station-initiated COT. Aspects of the present disclosure address Type-B PUSCH repetition across multiple base station fixed frame periods in this scenario, specifically, after the base station idle period in the next base station fixed frame period.

Other aspects of the present disclosure address scenarios of a UE-initiated COT. In these scenarios, the UE transmits at the beginning of the COT to occupy the COT for FBE mode communications. These aspects address orphan symbols that occur in the beginning of the next UE fixed frame period.

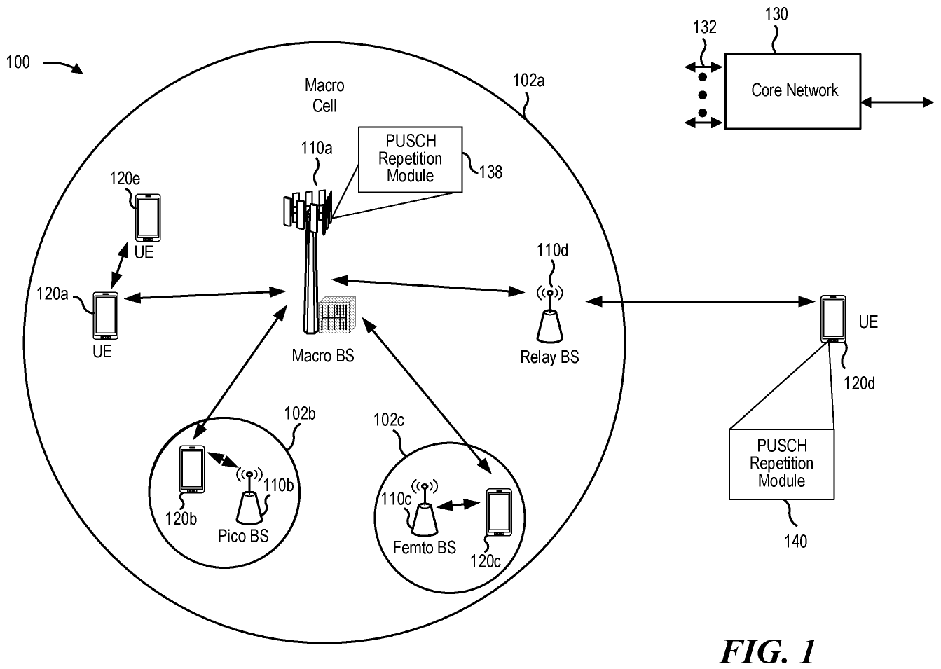

As indicated above, FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G node B, an access point, a transmit and receive point (TRP), and/or the like. Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

The UEs 120 may include a PUSCH repetition module 140. For brevity, only one UE 120d is shown as including the PUSCH repetition module 140. The PUSCH repetition module 140 may transmit, to a base station, during a shared base station first channel occupancy time (COT), a first physical uplink shared channel (PUSCH) actual repetition prior to an idle period in a first fixed frame period of the base station. The PUSCH repetition module 140 may also attempt to detect a downlink signal during a second COT in a second fixed frame period of the base station that occurs immediately after the idle period. The PUSCH repetition module 140 may further transmit a second PUSCH actual repetition in the second fixed frame period after the idle period, in response to detecting the downlink signal and in response to a processing timeline being satisfied. The PUSCH repetition module 140 may also drop all subsequent PUSCH repetitions, which are scheduled in a second fixed frame period that occurs immediately after the idle period. The PUSCH repetition module 140 may initiate a UE channel occupancy time (COT) in an orphan symbol at a beginning of a second fixed frame period of the UE, that follows the first fixed frame period of the UE. The PUSCH repetition module 140 may transmit a second PUSCH repetition in the second fixed frame period after the orphan symbol, in response to successfully initiating the UE COT. The PUSCH repetition module 140 may also receive, from a base station, a downlink control information (DCI) message or a radio resource control (RRC) configuration indicating a first physical uplink shared channel (PUSCH) repetition to be transmitted prior to an idle period in a first fixed frame period and a second PUSCH repetition to be transmitted in a second fixed frame period after the idle period and at the beginning of the second fixed frame period. The PUSCH repetition module 140 may treat the received DCI message or RRC configuration as an error case.

The core network 130 or the base stations 110 may include a PUSCH repetition module 138. For brevity, only one base stations 110a is shown as including the PUSCH repetition module 138. The PUSCH repetition module 138 may receive, from a user equipment (UE) operating in a frame based equipment (FBE) mode, during a shared base station first channel occupancy time (COT), a first physical uplink shared channel (PUSCH) actual repetition prior to an idle period in a first fixed frame period of the base station. The PUSCH repetition module 138 may also receive, from the UE, a second PUSCH actual repetition in a second fixed frame period that occurs immediately after the idle period, the second PUSCH actual repetition arriving after a beginning of the second fixed frame period, in response to the UE detecting a downlink signal and in response to a processing timeline of the UE being satisfied. The PUSCH repetition module 138 may schedule subsequent PUSCH repetitions in a second fixed frame period that occurs immediately after the idle period. The PUSCH repetition module 138 may also schedule subsequent PUSCH repetitions in a second fixed frame period that occurs immediately after the idle period. The PUSCH repetition module 138 may receive a cyclic prefix (CP) extension during an orphan symbol at a beginning of a second fixed frame period of the UE, that follows the first fixed frame period of the UE. The PUSCH repetition module 138 may also receive a second PUSCH repetition in the second fixed frame period after the orphan symbol, in response to the UE successfully initiating a UE channel occupancy time (COT) during the orphan symbol.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communications link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V21) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

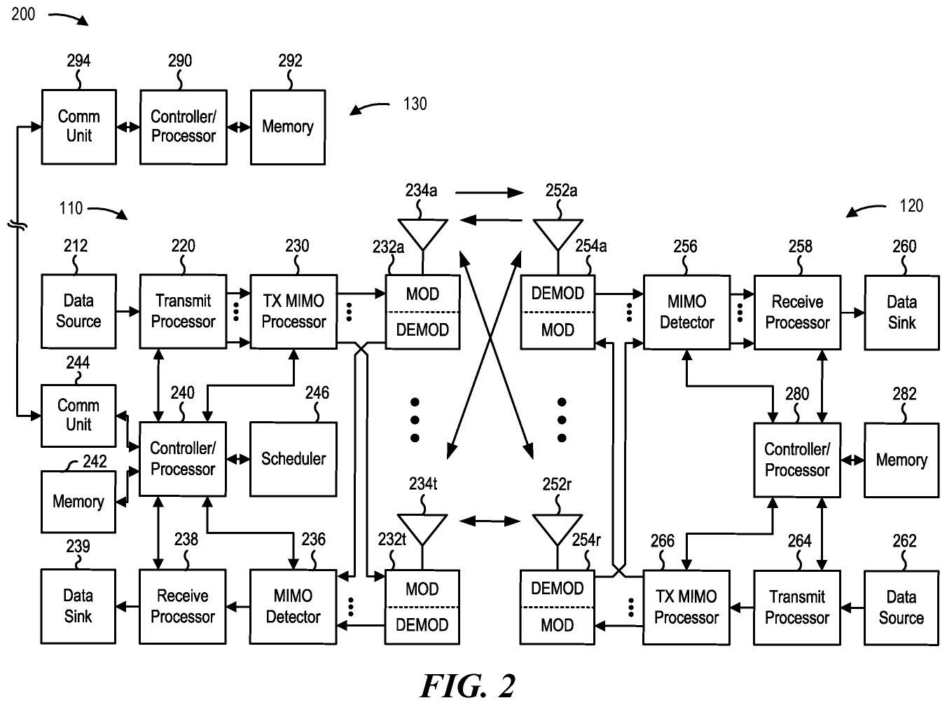

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for DFT-s-OFDM, CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

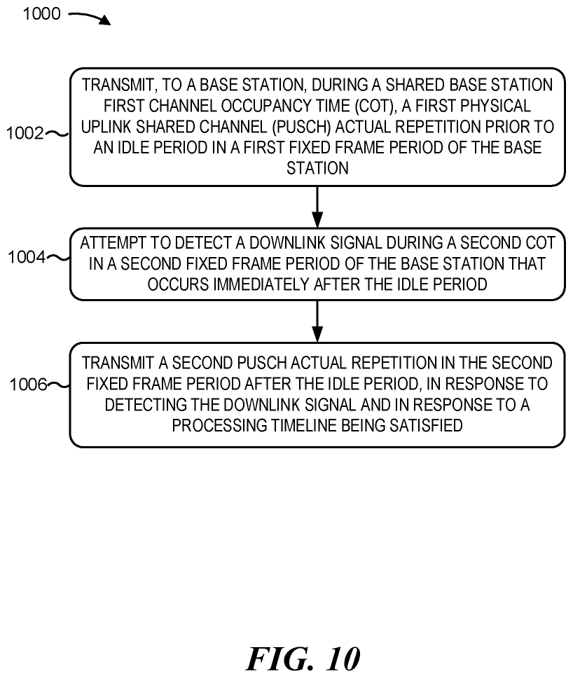

The controller/processor 240 of the base station 110, the controller/processor 280 of the UE 120, and/or any other component(s) of FIG. 2 may perform one or more techniques associated with PUSCH repetitions as described in more detail elsewhere. For example, the controller/processor 240 of the base station 110, the controller/processor 280 of the UE 120, and/or any other component(s) of FIG. 2 may perform or direct operations of, for example, the processes of FIGS. 10-16 and/or other processes as described. Memories 242 and 282 may store data and program codes for the base station 110 and UE 120, respectively. A scheduler 246 may schedule UEs for data transmission on the downlink and/or uplink.

In some aspects, the UE 120 and base station may include means for transmitting, means for attempting, means for dropping, means for initiating, means for receiving, means for treating, and/or means for scheduling. Such means may include one or more components of the UE 120 or base station 110 described in connection with FIG. 2.

As indicated above, FIG. 2 is provided merely as an example. Other examples may differ from what is described with regard to FIG. 2.

A physical uplink shared channel (PUSCH) is a set of time and frequency resources used for transmission from the UE to the base station. A PUSCH transmission, however, is not permitted to cross a slot boundary. Therefore, to avoid transmitting a long PUSCH across a slot boundary, the UE transmits multiple small PUSCH repetitions. The Third Generation Partnership Project (3GPP) Release-16 introduced PUSCH repetition Type-B to permit repetitions to be transmitted in consecutive sub-slots so one slot may contain more than one repetition of a transport block. For PUSCH repetition Type-B, the time domain resource is indicated by the base station for the first nominal repetition while the resources for the remaining repetitions are derived based on the resources for the first repetition and the uplink/downlink direction of individual symbols. If a nominal repetition crosses the slot boundary, downlink symbol, or invalid symbol, this nominal repetition is split (e.g., segmented) at the slot boundary, downlink symbol, or invalid symbol into multiple PUSCH repetitions. Therefore, the actual number of repetitions can be larger than the nominal number.

Wireless communications in unlicensed spectrum may occur in a semi-static channel access mode (e.g., frame-based equipment (FBE) mode). In the FBE mode, the UEs perform channel sensing in fixed time periods. Moreover, the transmissions start at specific points in time based on the fixed frame periods of the device initiating the channel occupancy time (COT). For UEs operating in FBE mode, PUSCH repetition Type-B orphan symbols are dropped. An orphan symbol is a single symbol after segmentation. If a nominal repetition overlaps with a set of symbols in an idle period associated with a base station's fixed frame period when the UE shares a base station-initiated COT for the nominal repetition, all symbols in the idle period are considered to be invalid symbols. Invalid symbols are not considered for an actual repetition. Similarly, if the set of symbols in an idle period are associated with a UE's fixed frame period in case the UE assumes a UE-initiated COT for the nominal repetition, all symbols in the idle period are considered to be invalid symbols. In other words, nominal repetitions are segmented around the idle period.

In a semi-static channel access mode (e.g., FBE mode), a UE may share a base station-initiated COT. Aspects of the present disclosure address Type-B PUSCH repetition across multiple base station fixed frame periods in this scenario, specifically, after the base station idle period in the next base station fixed frame period.

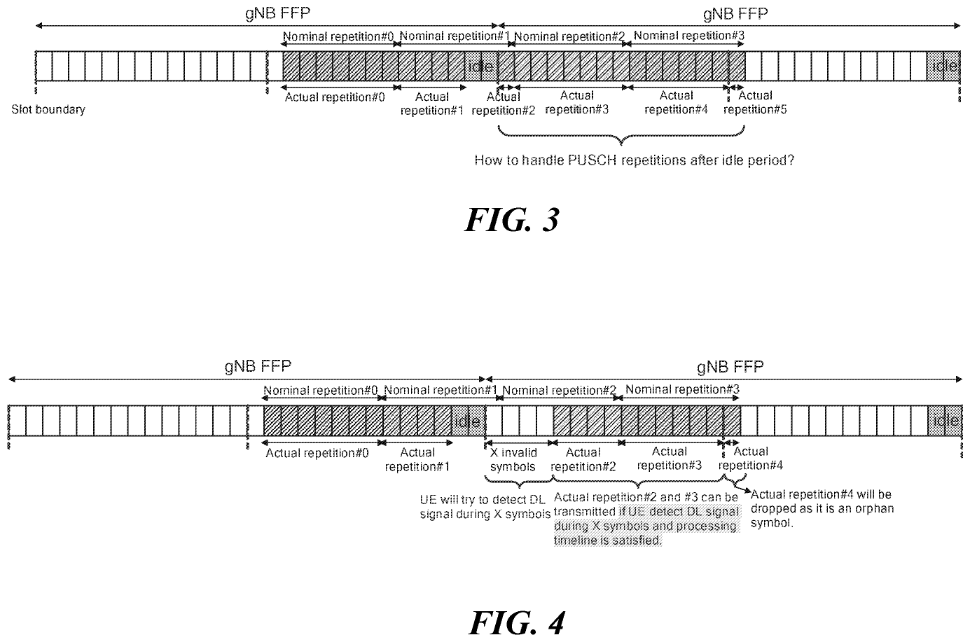

FIGS. 3-6 illustrate various timelines for physical uplink shared channel (PUSCH) repetitions after an idle period in a frame-based equipment (FBE) mode, according to aspects of the present disclosure. In the example shown in FIG. 3, the UE cannot transmit in the second fixed frame period (FFP) because a downlink signal was not detected during the second base station FFP. That is, a downlink signal should be detected at a beginning of a COT to enable the UE to share the COT and transmit during the COT. In the example of FIG. 3, all symbols in the second base station FFP are uplink symbols, preventing the UE from transmitting during the COT in the second base station FFP.

According to aspects of the present disclosure, the UE treats the first X symbols of the base station fixed frame period, in addition to the base station idle period, as invalid symbols. In these aspects, the PUSCH nominal repetition may be segmented around the symbols in the idle period and the X invalid symbols. During the X symbols, the UE attempts to detect a downlink signal to determine if the actual repetitions after the X symbols can be transmitted. In some aspects, the value of X can be radio resource control (RRC) configured. In other aspects, the value of X relates to a UE capability, or is hard coded.

All actual repetitions scheduled after a processing timeline in the next fixed frame period can be a starting point for uplink transmission in the shared base station COT. The processing timeline is the amount of time needed for a UE to detect and decode the downlink signal, and then prepare for uplink transmission, for example, by switching a transceiver from receive mode to transmit mode. The UE may start at the beginning of any actual transmission that satisfies the processing timeline, as opposed to starting at a second or later symbol of an actual transmission. The UE may start transmitting at the earliest starting point of an actual transmission that satisfies the processing timeline. In the example shown in FIG. 4, if the processing timeline is three symbols and the downlink signal is received in the first of the X invalid symbols, the UE may start transmitting at the beginning of actual repetition #2. If the processing timeline is four symbols, the UE waits until the first symbol of actual repetition #3, rather than starting in the second symbol of actual repetition #2. These aspects permit the UE to transmit after the processing delay, whenever the downlink signal is detected. In these aspects, the value of X need not be large to cover the processing, as the base station may assume any actual repetition starting point before a certain time cannot be transmitted.

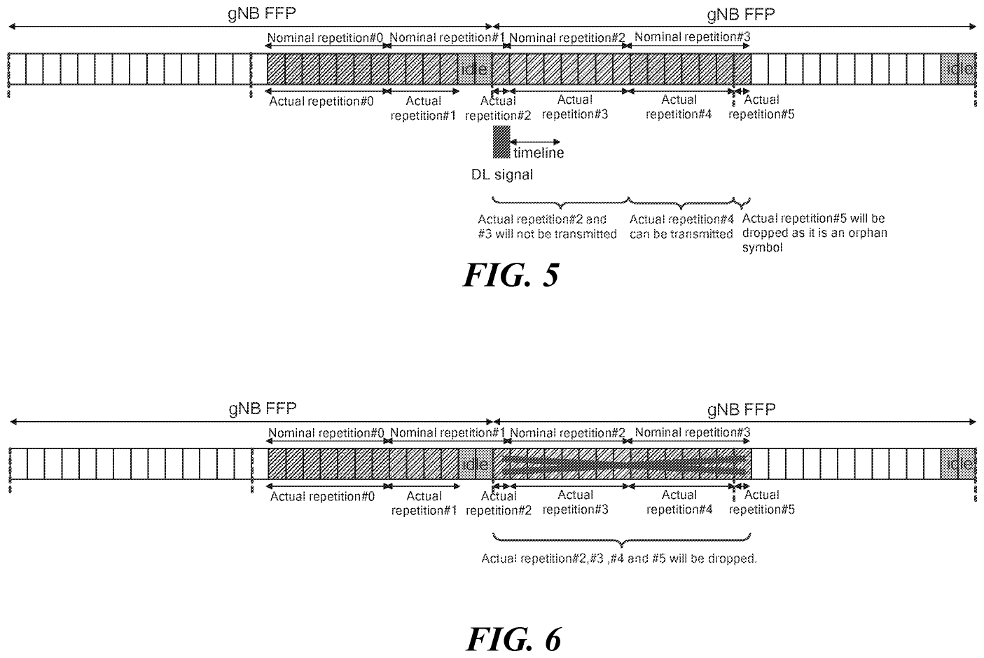

In other aspects of the present disclosure, the actual repetitions are determined such that a nominal PUSCH repetition is segmented around the symbols in the base station idle period when the UE shares a base station COT. In these aspects, the actual repetition can be transmitted only when a downlink signal is detected. Thus, the first actual repetition(s) in the second FFP are not transmitted. Only the actual repetitions after the processing timeline and detection of the downlink transmission may be transmitted. In FIG. 5, actual repetition #2 and #3 are not transmitted but actual transmission #4 is transmitted, assuming the downlink signal is received in the first downlink symbol of the second FFP and the processing timeline is three symbols. Although a UE capability indicates the processing timeline, the base station may not know which actual repetition will be transmitted, given that the base station may not know how fast the UE can actually process.

In still other aspects of the present disclosure, the UE drops the PUSCH repetitions in the next base station fixed frame period. FIG. 6 illustrates these aspects.

In yet other aspects, the UE treats any PUSCH repetition scheduled across a base station fixed frame period as an error case. In other words, the UE does not expect to be scheduled to transmit PUSCH repetitions across multiple base station fixed frame periods. Thus, the UE treats any DCI message or RRC configuration that schedules PUSCH repetitions across a fixed frame period as an error case.

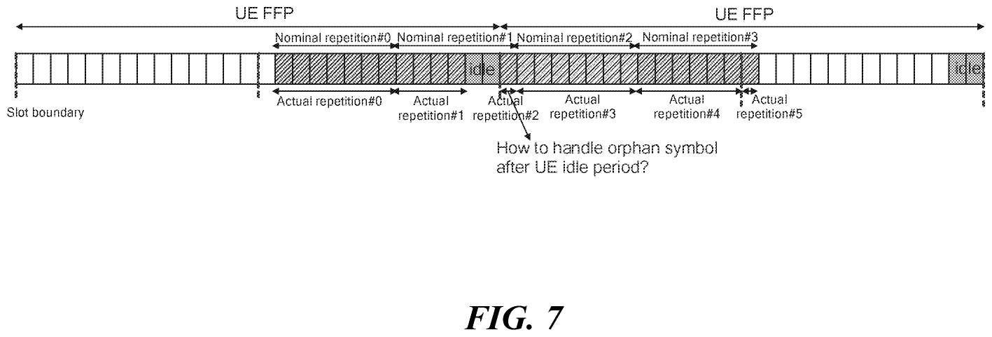

Other aspects of the present disclosure address scenarios of a UE-initiated COT, as seen in FIGS. 7-9. FIGS. 7-9 illustrate various timelines for physical uplink shared channel (PUSCH) repetitions after an idle period in a frame-based equipment (FBE) mode, according to aspects of the present disclosure. In these scenarios, the UE transmits at the beginning of the COT to occupy the COT for FBE mode communications. FIG. 7 shows an orphan symbol that occurs in the beginning of the next UE fixed frame period.

In some aspects of the present disclosure, the UE may treat the orphan symbol as an error case. In other words, the UE is not expected to be scheduled with an orphan symbol that occurs in the beginning of the UE fixed frame period.

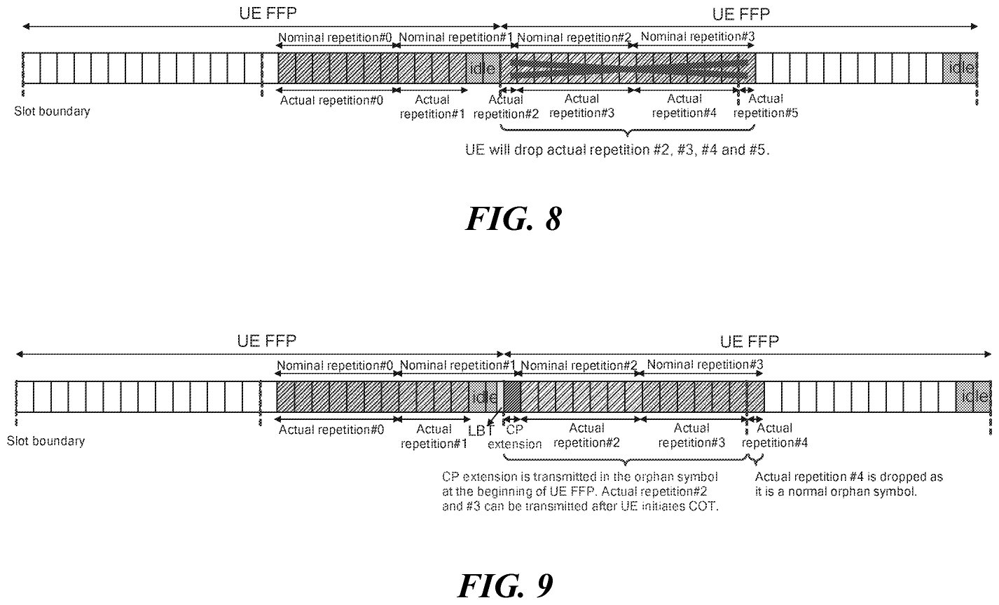

In other aspects, the UE drops the orphan symbol and the remaining repetitions after the orphan symbol. More specifically, the UE drops all subsequent PUSCH repetitions when the first actual PUSCH repetition in the second fixed frame period of the UE is an orphan symbol. As seen in FIG. 8, actual repetition #2 is an orphan symbol. Thus, the UE drops actual repetitions #2, #3, #4, and #5. This occurs because the UE cannot initiate the UE COT when nothing is transmitted at the beginning of the UE fixed frame period.

In still other aspects, the UE fills the orphan symbol at the beginning of the fixed frame period with a transmission to initiate the COT. The UE may use a cyclic prefix (CP) extension to fill the gap, initiating the UE COT by transmitting the cyclic prefix extension in the orphan symbol at the beginning of UE fixed frame period. The length of the CP extension may be an existing CP extension, e.g., C2*symbol length−16 us−timing advance (TA) where C2 is RRC configured. In other aspects, a new length of the CP extension is introduced. In these aspects, the UE transmits the remaining PUSCH repetitions after the orphan symbol if the UE successfully initiates the UE COT. FIG. 9 illustrates these aspects, where a listen before talk (LBT) occurs at the end of the idle period (e.g., during the sensing slot). If the LBT passes, the UE transmits a CP extension in the orphan symbol at the beginning of the UE second fixed frame period to initiate the COT in the second fixed frame period. As a result, the UE may transmit actual repetitions #2 and #3 after the UE initiates the COT.

As indicated above, FIGS. 3-9 are provided as examples. Other examples may differ from what is described with respect to FIGS. 3-9.

FIG. 10 is a flow diagram illustrating an example process 1000 performed, for example, by a user equipment (UE), in accordance with various aspects of the present disclosure. The example process 1000 is an example of processing type-B physical uplink shared channel (PUSCH) repetitions after an idle period in frame-based equipment (FBE). The operations of the process 1000 may be implemented by a UE 120.

At block 1002, the user equipment (UE) transmits, to a base station, during a shared base station first channel occupancy time (COT), a first physical uplink shared channel (PUSCH) actual repetition prior to an idle period in a first fixed frame period of the base station. For example, the UE (e.g., using the antenna 252, the DEMOD/MOD 254, TX MIMO processor 266, transmit processor 264, controller/processor 280, and/or memory 282) may transmit the first PUSCH actual repetition.

At block 1004, the user equipment (UE) attempts to detect a downlink signal during a second COT in a second fixed frame period of the base station that occurs immediately after the idle period. For example, the UE (e.g., using the antenna 252, the DEMOD/MOD 254, MIMO detector 256, receiver processor 254, controller/processor 280, and/or memory 282) may attempt to detect the downlink signal.

At block 1006, the user equipment (UE) transmits a second PUSCH actual repetition in the second fixed frame period after the idle period, in response to detecting the downlink signal and in response to a processing timeline being satisfied. For example, the UE (e.g., using the antenna 252, the DEMOD/MOD 254, TX MIMO processor 266, transmit processor 264, controller/processor 280, and/or memory 282) may transmit the second PUSCH actual repetition.

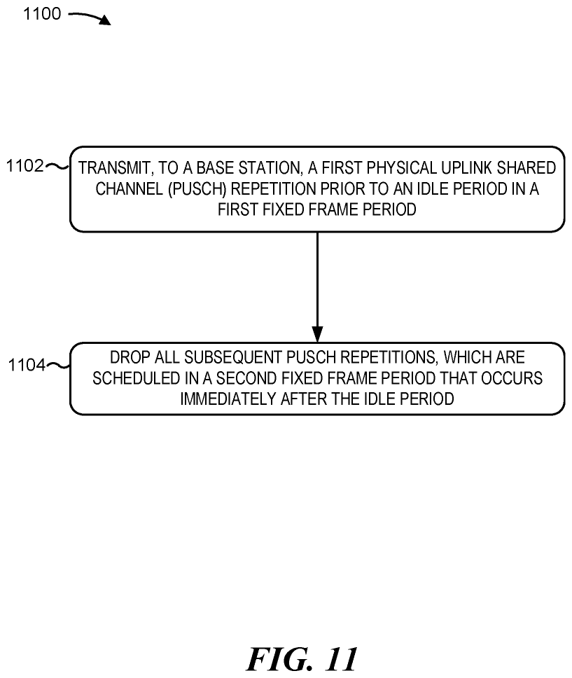

FIG. 11 is a flow diagram illustrating an example process 1100 performed, for example, by a user equipment (UE), in accordance with various aspects of the present disclosure. The example process 1100 is an example of processing type-B physical uplink shared channel (PUSCH) repetitions after an idle period in frame-based equipment (FBE) mode. The operations of process 1100 may be implemented by a UE 120.

At block 1102, the user equipment (UE) transmits, to a base station, a first physical uplink shared channel (PUSCH) repetition prior to an idle period in a first fixed frame period. For example, the UE (e.g., using the antenna 252, the DEMOD/MOD 254, TX MIMO processor 266, transmit processor 264, controller/processor 280, and/or memory 282) may transmit the first PUSCH repetition. At block 1104, the user equipment (UE) drops all subsequent PUSCH repetitions, which are scheduled in a second fixed frame period that occurs immediately after the idle period. For example, the UE (e.g., using the antenna 252, the DEMOD/MOD 254, TX MIMO processor 266, transmit processor 264, controller/processor 280, and/or memory 282) may drop the subsequent PUSCH repetitions.

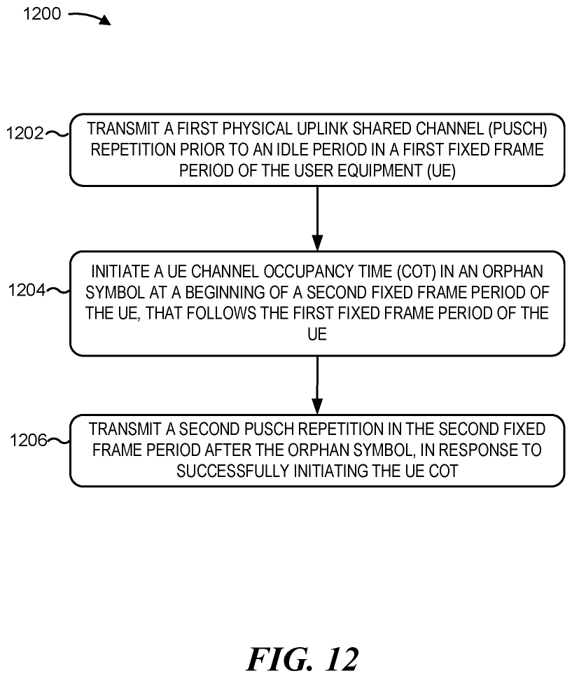

FIG. 12 is a flow diagram illustrating an example process 1200 performed, for example, by a user equipment (UE), in accordance with various aspects of the present disclosure. The example process 1200 is an example of processing type-B physical uplink shared channel (PUSCH) repetitions after an idle period in frame-based equipment (FBE) mode. The operations of process 1200 may be implemented by a UE 120. At block 1202, the user equipment (UE) transmits a first physical uplink shared channel (PUSCH) repetition prior to an idle period in a first fixed frame period of the USER Equipment (UE). For example, the UE (e.g., using the antenna 252, the DEMOD/MOD 254, TX MIMO processor 266, transmit processor 264, controller/processor 280, and/or memory 282) may transmit the first PUSCH repetition.

At block 1204, the user equipment (UE) initiates a UE channel occupancy time (COT) in an orphan symbol at a beginning of a second fixed frame period of the UE, that follows the first fixed frame period of the UE. For example, the UE (e.g., using the antenna 252, the DEMOD/MOD 254, TX MIMO processor 266, transmit processor 264, controller/processor 280, and/or memory 282) may initiate the UE COT. At block 1206, the user equipment (UE) transmit a second PUSCH repetition in the second fixed frame period after the orphan symbol, in response to successfully initiating the UE COT. For example, the UE (e.g., using the antenna 252, the DEMOD/MOD 254, TX MIMO processor 266, transmit processor 264, controller/processor 280, and/or memory 282) may transmit the second PUSCH repetition.

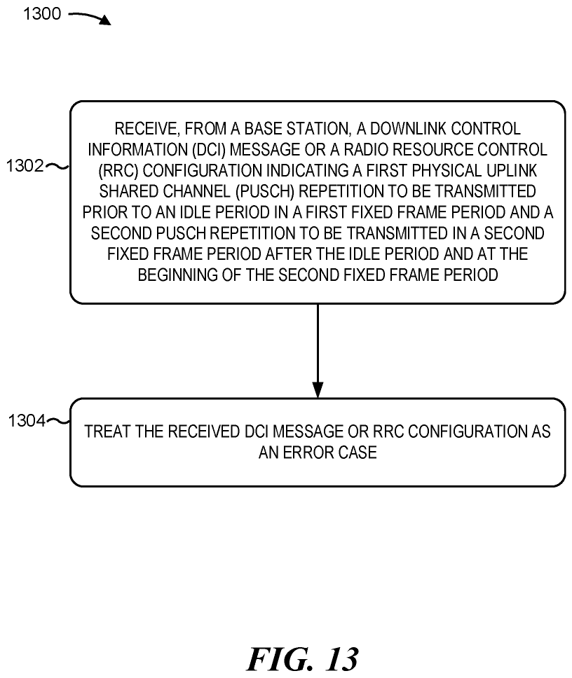

FIG. 13 is a flow diagram illustrating an example process 1300 performed, for example, by a user equipment (UE), in accordance with various aspects of the present disclosure. The example process 1300 is an example of processing type-B physical uplink shared channel (PUSCH) repetitions after an idle period in frame-based equipment (FBE) mode. The operations of process 1300 may be implemented by a UE 120.

At block 1302, the user equipment (UE) receives, from a base station, a downlink control information (DCI) message or a radio resource control (RRC) configuration indicating a first physical uplink shared channel (PUSCH) repetition to be transmitted prior to an idle period in a first fixed frame period and a second PUSCH repetition to be transmitted in a second fixed frame period after the idle period and at the beginning of the second fixed frame period. For example, the UE (e.g., using the antenna 252, the DEMOD/MOD 254, MIMO detector 256, receive processor 254, controller/processor 280, and/or memory 282) may receive the DCI message or the RRC configuration. At block 1304, the user equipment (UE) treats the received DCI message or RRC configuration as an error case. For example, the UE (e.g., using the controller/processor 280, and/or memory 282) may treat the received DCI message or RRC configuration as an error case.

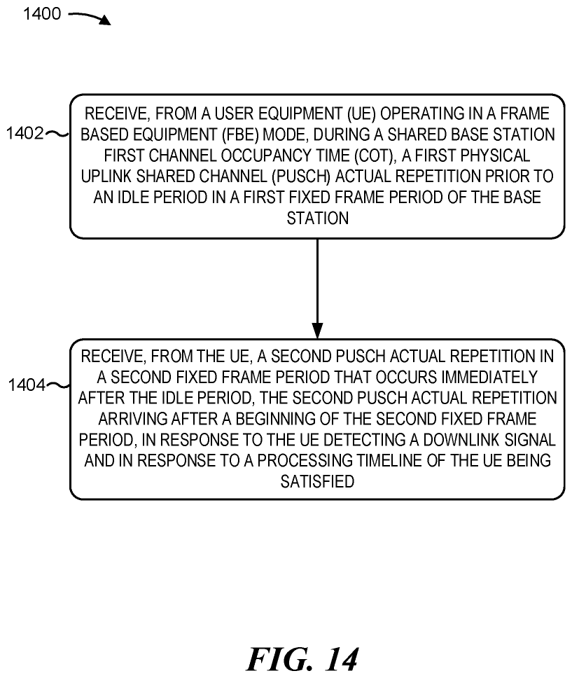

FIG. 14 is a flow diagram illustrating an example process 1400 performed, for example, by a base station, in accordance with various aspects of the present disclosure. The example process 1400 is an example of processing type-B physical uplink shared channel (PUSCH) repetitions after an idle period in frame-based equipment (FBE) mode. The operations of process 1400 may be implemented by a base station 110.

At block 1402, the base station receives, from a user equipment (UE) operating in a frame based equipment (FBE) mode, during a shared base station first channel occupancy time (COT), a first physical uplink shared channel (PUSCH) actual repetition prior to an idle period in a first fixed frame period of the base station. For example, the base station (e.g., using the antenna 234, receive processor 238, MOD/DEMOD 232, MIMO detector 236, controller/processor 240, and/or memory 242) may receive the PUSCH actual repetition. At block 1404, the base station receives, from the UE, a second PUSCH actual repetition in a second fixed frame period that occurs immediately after the idle period. The second PUSCH actual repetition arrives after a beginning of the second fixed frame period, in response to the UE detecting a downlink signal and in response to a processing timeline of the UE being satisfied. For example, the base station (e.g., using the antenna 234, receive processor 238, MOD/DEMOD 232, MIMO detector 236, controller/processor 240, and/or memory 242) may receive the second PUSCH actual repetition.

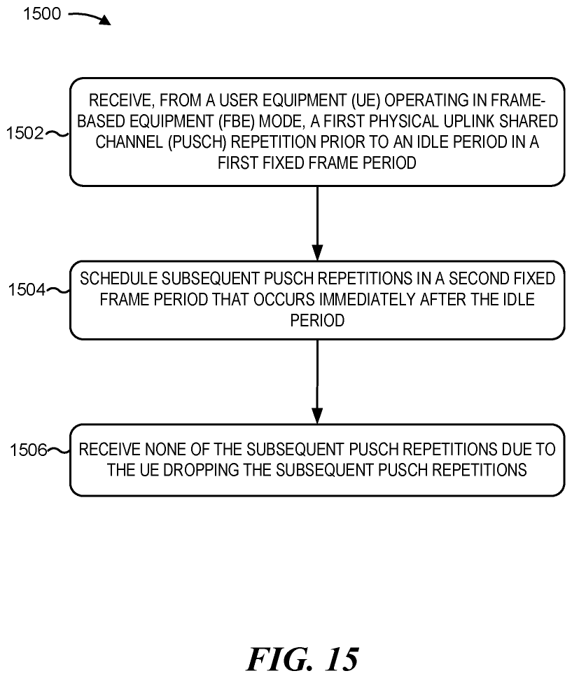

FIG. 15 is a flow diagram illustrating an example process 1500 performed, for example, by a base station, in accordance with various aspects of the present disclosure. The example process 1500 is an example of processing type-B physical uplink shared channel (PUSCH) repetitions after an idle period in frame-based equipment (FBE) mode. The operations of process 1500 may be implemented by a base station 110.

At block 1502, the base station receives, from a user equipment (UE) operating in frame-based equipment (FBE) mode, a first physical uplink shared channel (PUSCH) repetition prior to an idle period in a first fixed frame period. For example, the base station (e.g., using the antenna 234, receive processor 238, MOD/DEMOD 232, MIMO detector 236, controller/processor 240, and/or memory 242) may receive the first PUSCH repetition. At block 1504, the base station schedules subsequent PUSCH repetitions in a second fixed frame period that occurs immediately after the idle period. For example, the base station (e.g., using the antenna 234, transmit processor 220, MOD/DEMOD 232, Tx MIMO processor 230, the controller/processor 240, and/or memory 242) may schedule the PUSCH repetitions.

At block 1506, the base station receives none of the subsequent PUSCH repetitions due to the UE dropping the subsequent PUSCH repetitions. For example, the base station (e.g., using the antenna 234, MOD/DEMOD 232, MIMO detector 236, controller/processor 240, receive processor 238, and/or memory 242) receives no subsequent PUSCH repetition.

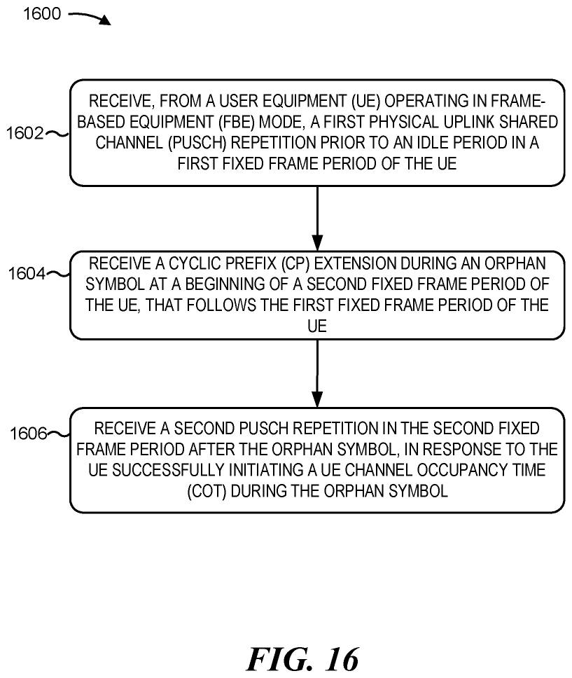

FIG. 16 is a flow diagram illustrating an example process 1600 performed, for example, by a base station, in accordance with various aspects of the present disclosure. The example process 1600 is an example of processing type-B physical uplink shared channel (PUSCH) repetitions after an idle period in frame-based equipment (FBE) mode. The operations of process 1600 may be implemented by a base station 110.

At block 1602, the base station receives, from a user equipment (UE) operating in frame-based equipment (FBE) mode, a first physical uplink shared channel (PUSCH) repetition prior to an idle period in a first fixed frame period of the UE. For example, the base station (e.g., using the antenna 234, receive processor 238, MOD/DEMOD 232, MIMO detector 236, controller/processor 240, and/or memory 242) may receive the first PUSCH repetition.

At block 1604, the base station receives a cyclic prefix (CP) extension during an orphan symbol at a beginning of a second fixed frame period of the UE, that follows the first fixed frame period of the UE. For example, the base station (e.g., using the antenna 234, MOD/DEMOD 232, MIMO detector 236, receive processor 238, controller/processor 240, and/or memory 242) may receive the CP extension.

At block 1606, the base station receives a second PUSCH repetition in the second fixed frame period after the orphan symbol, in response to the UE successfully initiating a UE channel occupancy time (COT) during the orphan symbol. For example, the base station (e.g., using the antenna 234, receive processor 238, MOD/DEMOD 232, MIMO detector 236, controller/processor 240, and/or memory 242) may receive the second PUSCH repetition.

### EXAMPLE ASPECTS

Aspect 1: A method of wireless communication by a user equipment (UE) operating in frame-based equipment (FBE) mode, comprising: transmitting, to a base station, during a shared base station first channel occupancy time (COT), a first physical uplink shared channel (PUSCH) actual repetition prior to an idle period in a first fixed frame period of the base station; attempting to detect a downlink signal during a second COT in a second fixed frame period of the base station that occurs immediately after the idle period; and transmitting a second PUSCH actual repetition in the second fixed frame period after the idle period, in response to detecting the downlink signal and in response to a processing timeline being satisfied.

Aspect 2: The method of Aspect 1, in which the attempting to detect the downlink signal occurs during a predetermined number of symbols occurring at a beginning of the second fixed frame period and the method further comprises: treating the predetermined number of symbols as invalid symbols; and segmenting a PUSCH nominal repetition around the idle period and the predetermined number of symbols.

Aspect 3: The method of Aspect 1, further comprising segmenting a PUSCH nominal repetition around a predetermined number of symbols occurring at a beginning of the second fixed frame period.

Aspect 4: The method of any of the preceding Aspects, in which the attempting to detect the downlink signal occurs during a predetermined number of symbols occurring at a beginning of the second fixed frame period and the method further comprises receiving, from the base station, a radio resource control (RRC) configuration indicating the predetermined number of symbols.

Aspect 5: The method of any of preceding Aspects 1-3, in which the attempting to detect the downlink signal occurs during a predetermined number of symbols occurring at a beginning of the second fixed frame period the predetermined number of symbols corresponding to a UE capability.

Aspect 6: The method of any of the preceding Aspects, further comprising starting uplink transmission in the second fixed frame period at a beginning of the second PUSCH actual repetition.

Aspect 7: A method of wireless communication by a user equipment (UE) operating in frame-based equipment (FBE) mode, comprising: transmitting, to a base station, a first physical uplink shared channel (PUSCH) repetition prior to an idle period in a first fixed frame period; and dropping all subsequent PUSCH repetitions, which are scheduled in a second fixed frame period that occurs immediately after the idle period.

Aspect 8: The method of Aspect 7, in which the first fixed frame period is a first base station fixed frame period and the second fixed frame period is a second base station fixed frame period.

Aspect 9: The method of Aspect 7, in which the first fixed frame period is a first UE fixed frame period and the second fixed frame period is a second UE fixed frame period.

Aspect 10: The method of any of the aspects 7-9, in which the dropping of all subsequent PUSCH repetitions is based on the first actual PUSCH repetition including an orphan symbol, which is scheduled at a beginning of the second UE fixed frame period.

Aspect 11: A method of wireless communication by a user equipment (UE) operating in frame-based equipment (FBE) mode, comprising: transmitting a first physical uplink shared channel (PUSCH) repetition prior to an idle period in a first fixed frame period of the UE; initiating a UE channel occupancy time (COT) in an orphan symbol at a beginning of a second fixed frame period of the UE, that follows the first fixed frame period of the UE; and transmitting a second PUSCH repetition in the second fixed frame period after the orphan symbol, in response to successfully initiating the UE COT.

Aspect 12: The method of Aspect 11, in which the initiating of the UE COT comprises transmitting a cyclic prefix (CP) extension during the orphan symbol.

Aspect 13: A method of wireless communication by a user equipment (UE) operating in frame-based equipment (FBE) mode, comprising: receiving, from a base station, a downlink control information (DCI) message or a radio resource control (RRC) configuration indicating a first physical uplink shared channel (PUSCH) repetition to be transmitted prior to an idle period in a first fixed frame period and a second PUSCH repetition to be transmitted in a second fixed frame period after the idle period and at the beginning of the second fixed frame period; and treating the received DCI message or RRC configuration as an error case.

Aspect 14: The method of Aspect 13, in which the first fixed frame period is a first fixed frame period of the base station and the second fixed frame period is a second fixed frame period of the base station.

Aspect 15: The method of Aspect 13, in which the first fixed frame period is a fixed frame period of the UE, the second fixed frame period is a second fixed frame period of the UE, and the second PUSCH repetition is an orphan symbol.

Aspect 16: A method of wireless communication by a base station, comprising: receiving, from a user equipment (UE) operating in a frame based equipment (FBE) mode, during a shared base station first channel occupancy time (COT), a first physical uplink shared channel (PUSCH) actual repetition prior to an idle period in a first fixed frame period of the base station; and receiving, from the UE, a second PUSCH actual repetition in a second fixed frame period that occurs immediately after the idle period, the second PUSCH actual repetition arriving after a beginning of the second fixed frame period, in response to the UE detecting a downlink signal and in response to a processing timeline of the UE being satisfied.

Aspect 17: The method of Aspect 16, further comprising transmitting, to the UE, a radio resource control (RRC) configuration indicating a predetermined number of symbols after the idle period for detecting the downlink signal.

Aspect 18: The method of Aspect 16, in which predetermined number of symbols after the idle period for detecting the downlink signal corresponds to a UE capability.

Aspect 19: The method of any of the aspects 16-18, further receiving the second PUSCH actual repetition in the second fixed frame period based on a scheduled beginning of the second PUSCH actual repetition.

Aspect 20: A method of wireless communication by a base station, comprising: receiving, from a user equipment (UE) operating in frame-based equipment (FBE) mode, a first physical uplink shared channel (PUSCH) repetition prior to an idle period in a first fixed frame period; scheduling subsequent PUSCH repetitions in a second fixed frame period that occurs immediately after the idle period; and receiving none of the subsequent PUSCH repetitions due to the UE dropping the subsequent PUSCH repetitions.

Aspect 21: The method of Aspect 20, in which the first fixed frame period is a first base station fixed frame period and the second fixed frame period is a second base station fixed frame period.

Aspect 22: The method of Aspect 20, in which the first fixed frame period is a first UE fixed frame period and the second fixed frame period is a second UE fixed frame period.

Aspect 23: The method of any of the aspects 20 or 22, in which the dropping of the subsequent PUSCH repetitions is based on the first actual PUSCH repetition including an orphan symbol, which is scheduled at a beginning of the second UE fixed frame period.

Aspect 24: A method of wireless communication by a base station, comprising: receiving, from a user equipment (UE) operating in frame-based equipment (FBE) mode, a first physical uplink shared channel (PUSCH) repetition prior to an idle period in a first fixed frame period of the UE; receiving a cyclic prefix (CP) extension during an orphan symbol at a beginning of a second fixed frame period of the UE, that follows the first fixed frame period of the UE; and receiving a second PUSCH repetition in the second fixed frame period after the orphan symbol, in response to the UE successfully initiating a UE channel occupancy time (COT) during the orphan symbol.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code-it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

1. A method of wireless communication by a user equipment (UE) operating in frame-based equipment (FBE) mode, comprising:
transmitting, to a base station, during a shared base station first channel occupancy time (COT), a first physical uplink shared channel (PUSCH) actual repetition prior to an idle period in a first fixed frame period of the base station;
attempting to detect a downlink signal during a second COT in a second fixed frame period of the base station that occurs immediately after the idle period; and
transmitting a second PUSCH actual repetition in the second fixed frame period after the idle period, in response to detecting the downlink signal and in response to a processing timeline being satisfied.

2. The method of claim 1, in which the attempting to detect the downlink signal occurs during a predetermined number of symbols occurring at a beginning of the second fixed frame period and the method further comprises:
treating the predetermined number of symbols as invalid symbols; and
segmenting a PUSCH nominal repetition around the idle period and the predetermined number of symbols.

3. The method of claim 1, further comprising segmenting a PUSCH nominal repetition around a predetermined number of symbols occurring at a beginning of the second fixed frame period.

4. The method of claim 1, in which the attempting to detect the downlink signal occurs during a predetermined number of symbols occurring at a beginning of the second fixed frame period and the method further comprises receiving, from the base station, a radio resource control (RRC) configuration indicating the predetermined number of symbols.

5. The method of claim 1, in which the attempting to detect the downlink signal occurs during a predetermined number of symbols occurring at a beginning of the second fixed frame period the predetermined number of symbols corresponding to a UE capability.

6. The method of claim 1, further comprising starting uplink transmission in the second fixed frame period at a beginning of the second PUSCH actual repetition.

7. A method of wireless communication by a user equipment (UE) operating in frame-based equipment (FBE) mode, comprising:
transmitting, to a base station, a first physical uplink shared channel (PUSCH) repetition prior to an idle period in a first fixed frame period; and
dropping all subsequent PUSCH repetitions, which are scheduled in a second fixed frame period that occurs immediately after the idle period.

8. The method of claim 7, in which the first fixed frame period is a first base station fixed frame period and the second fixed frame period is a second base station fixed frame period.

9. The method of claim 7, in which the first fixed frame period is a first UE fixed frame period and the second fixed frame period is a second UE fixed frame period.

10. The method of claim 9, in which the dropping of all subsequent PUSCH repetitions is based on the first actual PUSCH repetition including an orphan symbol, which is scheduled at a beginning of the second UE fixed frame period.

11-15. (canceled)

16. A method of wireless communication by a base station, comprising:
receiving, from a user equipment (UE) operating in a frame-based equipment (FBE) mode, during a shared base station first channel occupancy time (COT), a first physical uplink shared channel (PUSCH) actual repetition prior to an idle period in a first fixed frame period of the base station; and
receiving, from the UE, a second PUSCH actual repetition in a second fixed frame period that occurs immediately after the idle period, the second PUSCH actual repetition arriving after a beginning of the second fixed frame period, in response to the UE detecting a downlink signal and in response to a processing timeline of the UE being satisfied.

17. The method of claim 16, further comprising transmitting, to the UE, a radio resource control (RRC) configuration indicating a predetermined number of symbols after the idle period for detecting the downlink signal.

18. The method of claim 16, in which a predetermined number of symbols after the idle period for detecting the downlink signal corresponds to a UE capability.

19. The method of claim 16, further comprising receiving the second PUSCH actual repetition in the second fixed frame period based on a scheduled beginning of the second PUSCH actual repetition.

20-24. (canceled)
